(19) United States
(12) Patent Application Publication
(10) Pub. No.: US 2018/0045530 A1
(43) Pub. Date: Feb. 15, 2018

(54) SYSTEM AND METHOD FOR GENERATING AN ACOUSTIC SIGNAL FOR LOCALIZATION OF A POINT OF INTEREST

(71) Applicants: BlackBerry Limited, Waterloo (CA); 2236008 Ontario Inc., Waterloo (CA)

(72) Inventors: Phillip Alan Hetherington, Vancouver (CA); Leonard Charles Layton, Vancouver (CA)

(21) Appl. No.: 15/235,525

(22) Filed: Aug. 12, 2016

(51) Int. Cl. G01C 21/36; H04R 3/04; H04R 3/12

(52) U.S. Cl. CPC G01C 21/3629; H04R 3/12; H04R 3/04; G01C 21/3644; H04R 2499/13

(57) ABSTRACT

A method for generating an acoustic signal for localization of a point of interest may access a geographic location and an audio waveform associated with a point of interest. A geographic location of a vehicle may be determined. An orientation of the geographic location associated with the point of interest may be derived relative to the vehicle based on the geographic location associated with the point of interest and the determined geographic location of the vehicle. An acoustic signal including the audio waveform may be produced in two or more audio transducers where a human listener inside the vehicle perceives the produced acoustic signal to be spatially indicative of the derived orientation of the geographic location associated with the point of interest relative to the vehicle.

### BACKGROUND

### 1. Technical Field

The present disclosure relates to the field of processing audio signals. In particular, to a system and method for generating an acoustic signal for localization of a point of interest.

### 2. Related Art

Navigation systems may be utilized in an automotive vehicle to direct and/or inform a user. When driving a car, points of interests may appear on a navigation screen associated with the navigation system. Some of the points of interest may be relevant or irrelevant depending on the current situation. For example, a gas station may be a point of interest within the navigation system, but the gas station may not be relevant to the user if the gas tank is full, a rest stop has just been visited, and/or the engine/transmission/tire status is normal. If, however, the gas tank is currently low, a gas station point of interest becomes very relevant. Typically the user is required to look at the navigation screen to determine the nearest gas station. Looking at the navigation screen is a distraction and should be minimized if possible.

There is a need for a navigation system that provides feedback that reduces distractions.

### BRIEF DESCRIPTION OF DRAWINGS

The system and method may be better understood with reference to the following drawings and description. The components in the figures are not necessarily to scale, emphasis instead being placed upon illustrating the principles of the disclosure. Moreover, in the figures, like referenced numerals designate corresponding parts throughout the different views.

Other systems, methods, features and advantages will be, or will become, apparent to one with skill in the art upon examination of the following figures and detailed description. It is intended that all such additional systems, methods, features and advantages be included with this description and be protected by the following claims.

FIG. 1 is a schematic representation of an overhead view of an automobile in which a system for generating an acoustic signal for localization of a point of interest may be used.

FIG. 2 is a schematic representation of a system for generating an acoustic signal for localization of a point of interest.

FIG. 3 is a representation of a method for generating an acoustic signal for localization of a point of interest.

FIG. 4 is a further schematic representation of a system for generating an acoustic signal for localization of a point of interest.

### DETAILED DESCRIPTION

A method for generating an acoustic signal for localization of a point of interest may access a geographic location and an audio waveform associated with a point of interest. A geographic location of a vehicle may be determined. An orientation of the geographic location associated with the point of interest may be derived relative to the vehicle based on the geographic location associated with the point of interest and the determined geographic location of the vehicle. An acoustic signal including the audio waveform may be produced in two or more audio transducers where a human listener inside the vehicle perceives the produced acoustic signal to be spatially indicative of the derived orientation of the geographic location associated with the point of interest relative to the vehicle.

Navigation systems may be utilized in an automotive vehicle to direct and/or inform a user. When driving a car, points of interests (POIs) may appear on a navigation screen associated with the navigation system. Some of the points of interest may be relevant or irrelevant depending on the current situation. For example, a gas station may be a point of interest within the navigation system, but the gas station may not be relevant to the user if the gas tank is full, a rest stop has just been visited, and/or the engine/transmission/tire status is normal. If, however, the gas tank is currently low, a gas station point of interest becomes very relevant. Typically the user is required to look at the navigation screen to determine the nearest gas station. Looking at the navigation screen may be a distraction and should be minimized if possible.

Navigation systems may produce one or more audio waveforms to inform the driver of POIs. The audio waveforms may inform the driver of the type of POI and the approximate location of the POI utilizing sounds that may be associated with the POI. For example, a gas station may be associated with two bell sounds in quick succession. In another example, the POIs may be identified by a specific sound logo, whether chosen by the company represented by the POI (e.g. sound mark), the driver, or the car manufacturer. The specific sound logo, or sound logo, may be associated with advertising information for the company represented by the POI.

The audio waveform may be processed, or spatialized to indicate the direction or orientation of the POI with respect to the car. The processing may include panning and fading the audio waveform. The spatialization may be allocentric where, for example, an audio waveform heard on the right of the driver, then the driver turns to the right, now the logo is heard in front. Additionally, a loudness, pitch, reverberation or any other characteristic of sound that varies with distance may be applied to or manipulated to convey the distance to the POI. Conveying to the driver direction and distance via an intuitive acoustic mechanism is safer than having the driver continue to look at a screen.

Further improvements to reducing driver distraction may be possible when the navigation system is contextually aware. For example, the navigation system may generate sound overload for the driver if all POIs were acoustically presented equally. System awareness of the driver's state (have they just eaten, have they just visited three furniture showrooms, diner preference, presence of kids in the car . . . ) and the vehicle's state (does the car require fuel, are the tires running low . . . ) may be used to mute certain POIs and/or enhance certain POI sound logos over others, thereby reducing the false-positives and resulting annoyance factor. For example, if the driver has a preferred gas station then only the preferred station's sound logo may be presented acoustically when low on gas. However, if critically low on gas then all gas station sound logos may be presented. Contextually aware decision logic may be used to determine and/or select which POI audio waveform is played responsive to where the vehicle had been. For example, if the car has recently filled up at a gas station then why show or generate an audio waveform associated with a gas station POI until the car contains a lower level of fuel. In another example, if the car has recently been stopped of a period of time at a restaurant then why show or generate an audio waveform associated restaurant POIs. The audio waveforms could be muted or played softly in these cases, making the system far more relevant.

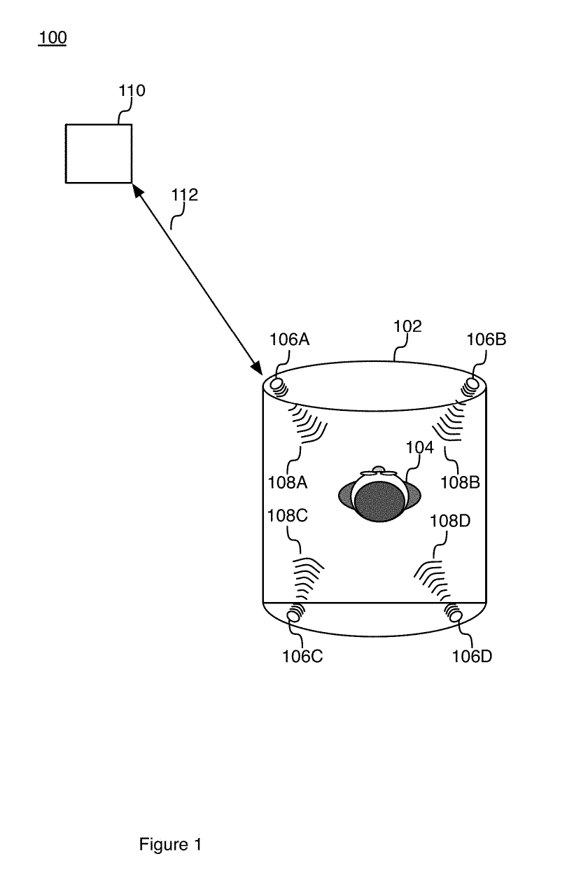

FIG. 1 is a schematic representation of an overhead view of an automobile in which a system for generating an acoustic signal for localization of a point of interest may be used. The system 100 is an example system for generating an acoustic signal for localization of a point of interest. The example system configuration includes automobile 102 (partially illustrated), or vehicle, may include multiple audio transducers (e.g. audio speakers) 106A, 106B, 106C and 106D (collectively or generically audio transducers 106) and may be occupied and/or operated by a driver, or user 104. A point of interest 110, may be located a distance 112 relative to the automobile 102. Each of the automobile 102 and the point of interest 108 may be a stationary object or a moving object. One or more of the audio transducers 106 may emit an audio waveform associated with the point of interest 110. The audio waveform may be produced in two or more audio transducers 106 where the user 104 inside the automobile 102 perceives the produced acoustic signals 108A, 108B, 108C and 108D (collectively or generically produced acoustic signals 108) to be spatially indicative of the point of interest 110 relative to the vehicle 102. The audio waveform may be modified utilizing panning, fading and/or through the addition of reverberation components so that the user 104 may perceive audio waveform to be associated with the approximate location of the point of interest 110. The produced audio signal 108 may be a component of, or mixed with, an other audio signal (not illustrated) such as, for example, broadcast radio content, music, a handsfree telephone conversation, active noise cancellation and/or engine sound enhancement that may be emitted by audio transducers 106.

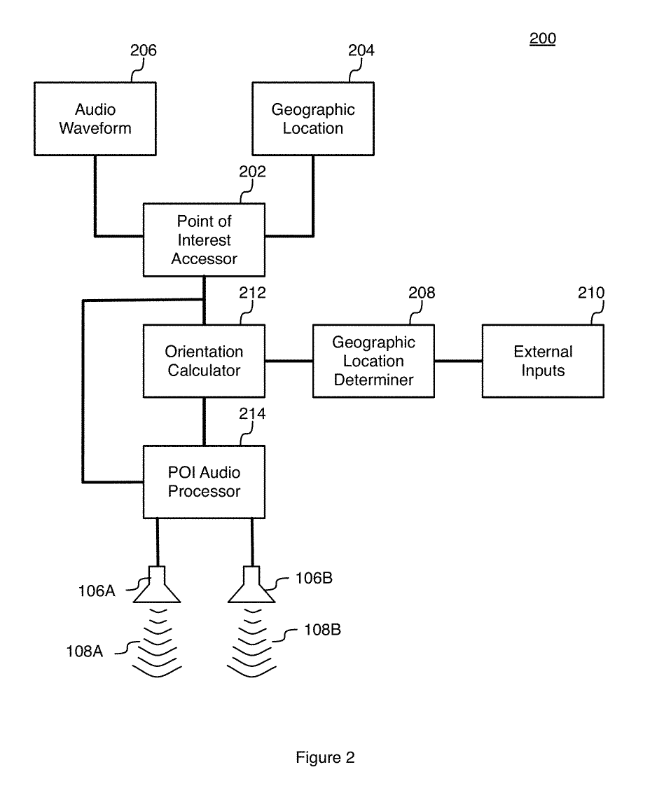

FIG. 2 is a schematic representation of a system for generating an acoustic signal for localization of a point of interest. The system 200 is an example system for generating an acoustic signal for localization of a point of interest. The example system configuration includes a point of interest accessor 202, one or more geographic locations 204, one or more audio waveforms 206, a geographic location determiner 208, one or more external inputs 210, an orientation calculator 212, an audio processor 214, two or more audio transducers 106 and one or more reproduced audio waveforms 108. The point of interest accessor 202 references the one or more geographic locations 204 and the one or more audio waveforms 206 associated with each of one or more points of interest. The one or more points of interest may be associated with, for example, a navigation system in the automobile 104 indicating locations including, for example, gas stations, hospitals, grocery stores and other landmarks. The one or more geographic locations 204 and the one or more audio waveforms 206 may be stored in the same location as the associated points of interest or in a different location accessed through a communications network including, for example, the Internet. The one or more geographic locations 204 associated with one or more points of interests may comprise, for example, one or more geographic position system (GPS) coordinates associated with one or more points of interest. The one or more audio waveforms 206 associated with one or more points of interest may comprise, for example, a prerecorded audio waveform and/or a synthesized audio waveform. The one or more audio waveforms 206 may comprise a sound logo associated with each of the one or more points of interest. The sound logo may be a sound associated with, for example, an advertisement associated with each of the one or more points of interest. An audio waveform 206 associated with a particular point of interest may be unique to the particular point of interest or may alternatively be unique to a set of multiple points of interest (including the particular point of interest) such as, for example, multiple locations of a franchised chain or multiple points of interest having a common classification (e.g. all hospitals).

The geographic location determiner 206 may locate the current geographic position of the automobile 104. The geographic location determiner 206 may receive external inputs 210. The external inputs may comprise for example, GPS coordinates from a GPS receiver and/or modified GPS coordinate calculated from additional automobile 104 sensors including gyroscope, wheel rotations, etc. The orientation calculator 212 utilizes the geographic position of the automobile 104 and the geographic position of the one or more points of interest to calculate the orientation of the one or more points of interest relative to the automobile 104. The orientation calculator 212 may utilize the orientation of the automobile 104 and assume that the automobile occupants face the forward driving direction or the automobile 104. The orientation calculator 212 calculations may include a 360-degree orientation of the one or more points of interest in two dimension (2D) and the distance between the automobile 104 and the one or more points of interest. Alternatively or in addition the geographic location determiner 208 and the orientation calculator 212 may receive and process external inputs including elevation information and may calculate the orientation and the distance to the one or more points of interest in three dimensions (3D). The orientation and the distance may be determined and represented relative to the location and orientation of the automobile 104. Orientation of the automobile 104 may be derived from time sequence analysis of a series of determined location of the automobile 104 over time and/or other external inputs including, for example, a compass bearing.

The POI audio processor 214 modifies the received one or more audio waveforms 206 responsive to the output of the orientation calculator 212. The one or more audio waveforms 206 may be processed, or spatialized, to indicate the direction of the POI with respect to the automobile 104. The direction of the POI with respect to the automobile 104 may be represent in 2D or alternatively in 3D. The processing may include, for example, panning and fading the audio waveform. The processing may be allocentric as described above. Additional processing may occur including, for example, modification of the loudness, pitch, adding reverberation components or any other characteristic of sound that varies with distance may be applied to or manipulated to convey the distance to the point of interest. The processed one or more audio waveforms 206 are output by the POI audio processor 214 and emitted by the two or more audio transducers 106. Conveying to the driver direction and distance via an intuitive acoustic mechanism may be safer than having the driver continue to look at the navigation screen.

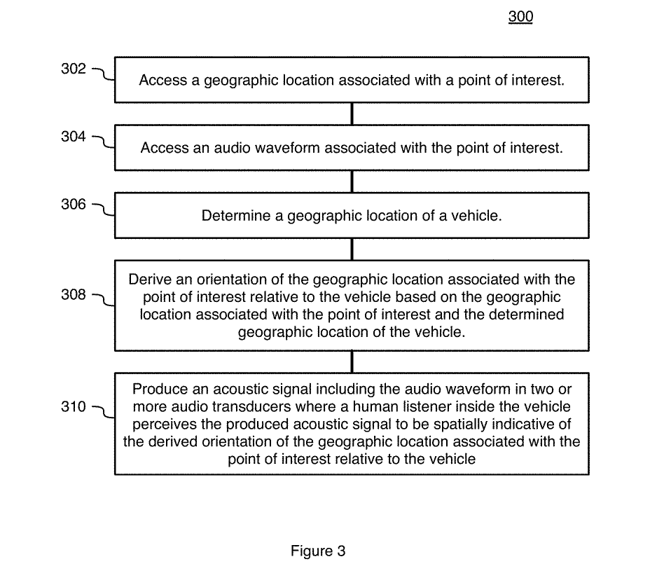

FIG. 3 is a representation of a method for generating an acoustic signal for localization of a point of interest. The method 300 may be, for example, implemented using any of the systems 100, 200 and 400 described herein with reference to FIGS. 1, 2 and 4. The method 300 may include the following acts. Accessing a geographic location associated with a point of interest 302. Accessing an audio waveform associated with the point of interest 304. Determining a geographic location of a vehicle 306. Deriving an orientation of the geographic location associated with the point of interest relative to the vehicle based on the geographic location associated with the point of interest and the determined geographic location of the vehicle 308. Producing an acoustic signal including the audio waveform in two or more audio transducers where a human listener inside the vehicle perceives the produced acoustic signal to be spatially indicative of the derived orientation of the geographic location associated with the point of interest relative to the vehicle 310.

Each of the steps 302, 304, 306, 308 and 310 may be repeated (individually or collectively) on a periodic and/or asynchronous basis in response to any of the passage of time, receiving revised or updated external inputs and receiving additional external inputs. The repeating of the above described steps allows the perceived spatial indication of the orientation of the geographic location of the point of interest to change (e.g be updated) in response to movement over time of the vehicle relative to the point of interest.

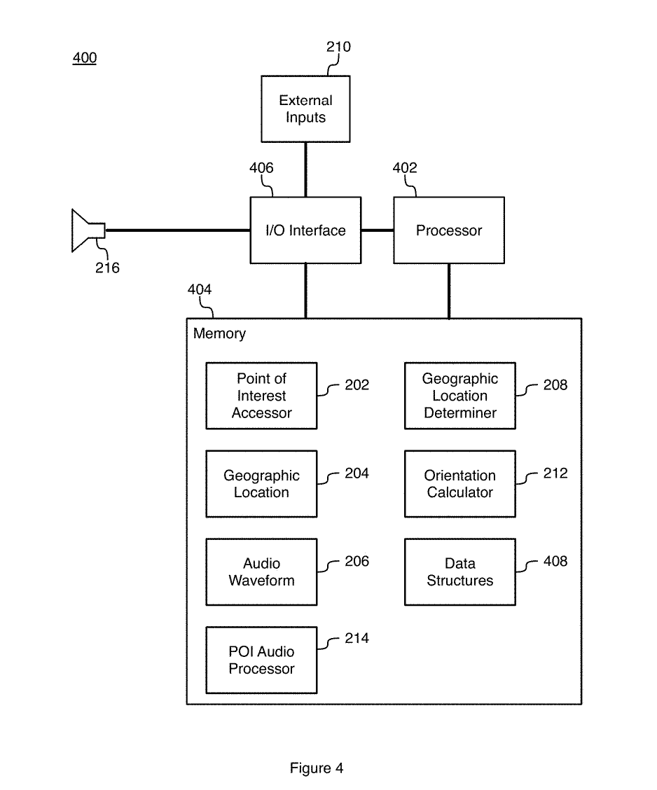

FIG. 4 is a further schematic representation of a system for generating an acoustic signal for localization of a point of interest. The system 400 comprises a processor 402, memory 404 (the contents of which are accessible by the processor 402) and an input/output (I/O) interface 406. The memory 404 may store instructions which when executed using the process 402 may cause the system 400 to render the functionality associated with generating an acoustic signal for localization of a point of interest as described herein. For example, the memory 404 may store instructions which when executed using the processor 402 may cause the system 400 to render the functionality associated with the point of interest accessor 202, the geographic location determiner 208, the orientation calculator 212 and the POI audio processor 214 as described herein. In addition, data structures, temporary variables and other information may be stored in data structures 408.

The processor 402 may comprise a single processor or multiple processors that may be disposed on a single chip, on multiple devices or distributed over more that one system. The processor 402 may be hardware that executes computer executable instructions or computer code embodied in the memory 404 or in other memory to perform one or more features of the system. The processor 402 may include a general purpose processor, a central processing unit (CPU), a graphics processing unit (GPU), an application specific integrated circuit (ASIC), a digital signal processor (DSP), a field programmable gate array (FPGA), a digital circuit, an analog circuit, a microcontroller, any other type of processor, or any combination thereof.

The memory 404 may comprise a device for storing and retrieving data, processor executable instructions, or any combination thereof. The memory 404 may include non-volatile and/or volatile memory, such as a random access memory (RAM), a read-only memory (ROM), an erasable programmable read-only memory (EPROM), or a flash memory. The memory 404 may comprise a single device or multiple devices that may be disposed on one or more dedicated memory devices or on a processor or other similar device. Alternatively or in addition, the memory 404 may include an optical, magnetic (hard-drive) or any other form of data storage device.

The memory 404 may store computer code, such as the point of interest accessor 202, the geographic location determiner 208, the orientation calculator 212 and the POI audio processor 214 as described herein. The computer code may include instructions executable with the processor 402. The computer code may be written in any computer language, such as C, C++, assembly language, channel program code, and/or any combination of computer languages. The memory 404 may store information in data structures including, for example, the one or more audio waveforms 206, the one or more geographic locations 204 and information representative one or more parameters of the POI audio processor 214.

The I/O interface 406 may be used to connect devices such as, for example, the audio transducers 106, the external inputs 210 and to other components of the system 400.

All of the disclosure, regardless of the particular implementation described, is exemplary in nature, rather than limiting. The system 400 may include more, fewer, or different components than illustrated in FIG. 4. Furthermore, each one of the components of system 400 may include more, fewer, or different elements than is illustrated in FIG. 4. Flags, data, databases, tables, entities, and other data structures may be separately stored and managed, may be incorporated into a single memory or database, may be distributed, or may be logically and physically organized in many different ways. The components may operate independently or be part of a same program or hardware. The components may be resident on separate hardware, such as separate removable circuit boards, or share common hardware, such as a same memory and processor for implementing instructions from the memory. Programs may be parts of a single program, separate programs, or distributed across several memories and processors.

The functions, acts or tasks illustrated in the figures or described may be executed in response to one or more sets of logic or instructions stored in or on computer readable media. The functions, acts or tasks are independent of the particular type of instructions set, storage media, processor or processing strategy and may be performed by software, hardware, integrated circuits, firmware, micro code and the like, operating alone or in combination. Likewise, processing strategies may include multiprocessing, multitasking, parallel processing, distributed processing, and/or any other type of processing. In one embodiment, the instructions are stored on a removable media device for reading by local or remote systems. In other embodiments, the logic or instructions are stored in a remote location for transfer through a computer network or over telephone lines. In yet other embodiments, the logic or instructions may be stored within a given computer such as, for example, a CPU.

While various embodiments of the system and method for generating an acoustic signal for localization of a point of interest, it will be apparent to those of ordinary skill in the art that many more embodiments and implementations are possible within the scope of the present invention. Accordingly, the invention is not to be restricted except in light of the attached claims and their equivalents.

1. A method for generating an acoustic signal for localization of a point of interest comprising:
accessing a geographic location associated with a point of interest;
accessing an audio waveform associated with the point of interest;
determining a geographic location of a vehicle;
deriving an orientation of the geographic location associated with the point of interest relative to the vehicle based on the geographic location associated with the point of interest and the determined geographic location of the vehicle; and
producing an acoustic signal including the audio waveform in two or more audio transducers where a human listener inside the vehicle perceives the produced acoustic signal to be spatially indicative of the derived orientation of the geographic location associated with the point of interest relative to the vehicle.

2. The method for generating an acoustic signal for localization of a point of interest of claim 1, where the geographic location is associated with one or more global positioning system coordinates.

3. The method for generating an acoustic signal for localization of a point of interest of claim 1, where the audio waveform comprises any one or more of: a prerecorded audio waveform and a synthesized audio waveform.

4. The method for generating an acoustic signal for localization of a point of interest of claim 1, where the audio waveform associated with the point of interest comprises a sound logo.

5. The method for generating an acoustic signal for localization of a point of interest of claim 1, where the derived orientation includes any one or more indicators of a bearing, a direction, a distance and an evaluation.

6. The method for generating an acoustic signal for localization of a point of interest of claim 1, where the produced acoustic signal is allocentric.

7. The method for generating an acoustic signal for localization of a point of interest of claim 1, where producing an acoustic signal including the audio waveform includes modifying any one or more of: panning ratios, fading ratio, loudness, pitch and reverberation.

8. The method for generating an acoustic signal for localization of a point of interest of claim 1, where producing an acoustic signal includes processing the acoustic signal responsive to changes over time of the orientation of the vehicle relative to the points of interest.

9. A system for generating an acoustic signal for localization of a point of interest comprising:
an accessor for accessing a geographic location associated with a point of interest;
an accessor accessing an audio waveform associated with the point of interest;
a determiner for determining a geographic location of a vehicle;
a deriver for deriving an orientation of the geographic location associated with the point of interest relative to the vehicle based on the geographic location associated with the point of interest and the determined geographic location of the vehicle; and
a producer for producing an acoustic signal including the audio waveform in two or more audio transducers where a human listener inside the vehicle perceives the produced acoustic signal to be spatially indicative of the derived orientation of the geographic location associated with the point of interest relative to the vehicle.

10. The system for generating an acoustic signal for localization of a point of interest of claim 1, where the geographic location is associated with one or more global positioning system coordinates.

11. The system for generating an acoustic signal for localization of a point of interest of claim 1, where the audio waveform comprises any one or more of: a prerecorded audio waveform and a synthesized audio waveform.

12. The system for generating an acoustic signal for localization of a point of interest of claim 1, where the audio waveform associated with the point of interest comprises a sound logo.

13. The system for generating an acoustic signal for localization of a point of interest of claim 1, where the derived orientation includes any one or more indicators of a bearing, a direction, a distance and an evaluation.

14. The system for generating an acoustic signal for localization of a point of interest of claim 1, where the produced acoustic signal is allocentric.

15. The system for generating an acoustic signal for localization of a point of interest of claim 1, where producing an acoustic signal including the audio waveform includes modifying any one or more of: panning ratios, fading ratio, loudness, pitch and reverberation.

16. The system for generating an acoustic signal for localization of a point of interest of claim 1, where producing an acoustic signal includes processing the acoustic signal responsive to changes over time of the orientation of the vehicle relative to the points of interest.
